(19) United States
(12) Patent Application Publication
(10) Pub. No.: US 2026/0333302 A1
(43) Pub. Date: Oct. 22, 2026

(54) METHOD AND DEVICE FOR DETERMINING LINK, AND STORAGE MEDIUM AND CHIP

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 18/993,277

(22) PCT Filed: Jul. 13, 2022
(86) PCT No.: PCT/CN2022/105568

§ 371 Date: Jan. 10, 2025

(51) Int. Cl. H04W 72/02; H04W 72/563; H04W 92/18

(52) U.S. Cl. CPC H04W 72/02; H04W 72/563; H04W 92/18

(57) ABSTRACT

A method for determining a link, includes: determining, in response to determining that a sidelink and a non-sidelink of a first terminal device are unable to transmit simultaneously, a resource type of the sidelink; and determining a target link for communication from the sidelink and the non-sidelink according to the resource type.

### CROSS-REFERENCE TO RELATED APPLICATIONS

The present application is a U.S. National Stage of International Application No. PCT/CN2022/105568, filed on Jul. 13, 2022, the contents of all of which are incorporated herein by reference in their entirety for all purposes.

### BACKGROUND OF THE INVENTION

With the development of wireless communication technology, in order to realize direct communication between terminal devices, 3GPP (3rd Generation Partnership Project) defines a sidelink (also referred to as a direct link or a side link) communication mode. For example, a typical application scenario of sidelink communication is Vehicle-to-Everything (V2X).

### SUMMARY OF THE INVENTION

The present disclosure relates to the technical field of communications and provides a method and device for determining a link, a storage medium and a chip.

According to a first aspect of an embodiment of the present disclosure, a method for determining a link is provided. The method is performed by a first terminal device and includes:
determining, in response to determining that a sidelink and a non-sidelink of the first terminal device are unable to transmit simultaneously, a resource type corresponding to the sidelink; and
determining a target link for communication from the sidelink and the non-sidelink according to the resource type.

According to a second aspect of an embodiment of the present disclosure, a method for determining a link is provided. The method is performed by an access network device and includes:
determining a first parameter; and
transmitting the first parameter to a first terminal device, where the first parameter is configured to determine a first link selection threshold in a case where a resource type used by a sidelink is an unlicensed resource to instruct the first terminal device to determine a resource-link correspondence relationship according to the first parameter, determine a target link selection threshold corresponding to the resource type of the sidelink according to the resource-link correspondence relationship, and determine a target link for communication according to the target link selection threshold.

According to a third aspect of an embodiment of the present disclosure, an electronic device is provided. The device includes:
one or more processors; and
a memory that stores processor-executable instructions;
where the one or more processors are collectively configured to:
in response to determining that a sidelink and a non-sidelink of the first terminal device are unable to transmit simultaneously, determine a resource type corresponding to the sidelink; and
determine a target link for communication from the sidelink and the non-sidelink according to the resource type.

According to a fourth aspect of an embodiment of the present disclosure, an electronic device is provided. The device includes:
one or more processors; and
a memory that stores processor-executable instructions;
where the processor-executable instructions when collectively executed by the one or more processors cause the electronic device to act as the access network device and perform the method according to the second aspect of the present disclosure.

It is to be understood that the above general description and the following detailed description are exemplary and explanatory merely and are not restrictive of the present disclosure.

### BRIEF DESCRIPTION OF DRAWINGS

The accompanying drawings herein, which are incorporated in and constitute a part of the specification, illustrate embodiments consistent with the present disclosure and, together with the description, serve to explain the principles of the present disclosure.

FIG. 1 is a schematic diagram illustrating a communication system according to an example.

FIG. 2 is a flowchart illustrating a method for determining a link according to an example.

FIG. 3 is a flowchart illustrating a method for determining a link according to an example.

FIG. 4 is a flowchart illustrating a method for determining a link according to an example.

FIG. 5 is a flowchart illustrating a method for determining a link according to an example.

FIG. 6 is a flowchart illustrating a method for determining a link according to an example.

FIG. 7 is a block diagram illustrating a device for determining a link according to an example.

FIG. 8 is a block diagram illustrating a device for determining a link according to an example.

FIG. 9 is a block diagram illustrating a device for determining a link according to an example.

FIG. 10 is a block diagram illustrating a device for determining a link according to an example.

FIG. 11 is a block diagram illustrating a device for determining a link according to an example.

### DETAILED DESCRIPTION OF THE INVENTION

The examples will be described in detail herein, and examples thereof are shown in the accompanying drawings. When the following description involves the accompanying drawings, unless otherwise indicated, the same numbers in different accompanying drawings indicate the same or similar elements. The implementations described in the following examples are not all the implementations consistent with the present disclosure. On the contrary, these implementations are simply examples of devices and methods consistent with some aspects of the present disclosure, as detailed in the appended claims.

It needs to be noted that all actions to obtain signals, information or data in the present disclosure are carried out in accordance with corresponding data protection regulations and policies of the country where they are located and with the authorization of the owners of the respective devices.

The terms “first,” “second” and the like in the description of the present disclosure are used to distinguish similar objects, but not necessarily understood to describe a specific order or precedence order. In addition, in the description of the reference drawings, the same symbol in different drawings represents the same element, unless the contrary is stated.

In the description of the present disclosure, unless otherwise specified, “a plurality of” means two or more, and other quantifiers are similar thereto; and “at least one of the following,” “one or more,” or similar expressions means any combination of these terms, including a single item or any combination of a plurality of items. For example, one or more of a, b, or c may be represented as a, b, c, a-b, a-c, b-c, or a-b-c, where a, b, and c may be single or multiple. The term “and/or” describes an association relationship of the corresponding objects, indicating three kinds of relationship. For example, A and/or B may be expressed as: A exists alone, A and B exist concurrently, and B exists alone, where A and B may be singular or plural.

Although operations are depicted in the accompanying drawings in a particular order in the embodiments of the present disclosure, this is not construed such that such operations need to be performed in the particular order shown, or in a sequential order, or all illustrated operations need to be performed to achieve desirable results. In certain circumstances, multitasking and parallel processing may be advantageous.

In the V2X, each vehicle may serve as a terminal device, and the terminal devices may communicate with each other via a sidelink, and for example, may transmit information via a direct link, thereby effectively reducing a communication delay. After the introduction of sidelink communication, a terminal device may have a plurality of links (for example, a sidelink and a non-sidelink) that have to-be-transmitted data and need to be transmit simultaneously. In some scenarios (e.g., resource conflict, insufficient power, etc.), the sidelink and the non-sidelink (e.g., an uplink) are unable to transmit simultaneously. In this case, it is necessary to determine which link is used first for transmission. If both the sidelink and the non-sidelink have to-be-transmitted data but are unable to transmit simultaneously, one link may be selected for transmission by comparing logical channel priorities in the related art. However, there is a problem of not being able to reasonably select a target link, which may cause sidelink transmission failure and affect the communication quality between terminal devices.

In order to solve the above problem, the present disclosure provides a method and device for determining a link, a storage medium, and a chip.

The following first describes an implementation environment of the embodiments of the present disclosure.

The technical solutions of the embodiments of this application may be applied to various communication systems. The communication systems may include one or more of a 4G (the 4th Generation) communication system, a 5G (the 5th Generation) communication system, and other future wireless communication systems (such as 6G). The communication system may also include one or more of a public land mobile network (PLMN), a device-to-device (D2D) communication system, a machine to machine (M2M) communication system, an Internet of Things (IoT) communication system, a vehicle-to-everything (V2X) communication system, or other communication systems.

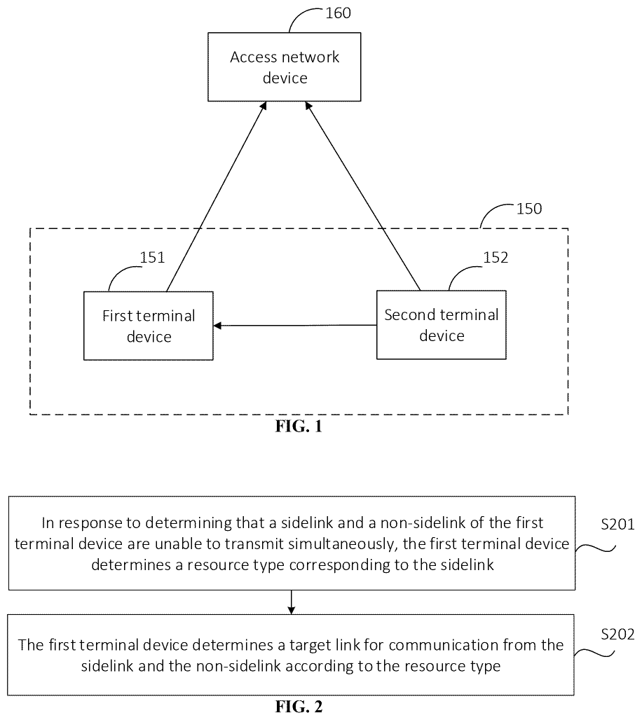

FIG. 1 is a schematic diagram illustrating a communication system according to an example. As shown in FIG. 1, the communication system may include a terminal device 150 and an access network device 160. The communication system can be used to support 4G network access technology, for example, Long Term Evolution (LTE) access technology, or 5G network access technology, such as New Radio Access Technology (New RAT), or other future wireless communication technologies. It is to be noted that in the communication system, a quantity of both access network devices and terminal devices can be one or more. A quantity of access network devices and terminal devices in the communication system shown in FIG. 1 is merely an adaptive example, which is not limited in the present disclosure.

The access network device 160 in FIG. 1 may be used to support terminal access. For example, the access network device 160 may be an evolutional Node B (eNB or eNodeB) in LTE. The access network device 160 may also be the next Generation Node B (gNB or gNodeB) in a 5G network. The access network device 160 may also be a NG radio access network (NG-RAN) device in the 5G network. The access network device 160 may also be a base station in a future-evolved public land mobile network (PLMN), a broadband network gateway (BNG), an aggregation switch, or a non-3rd Generation Partnership Project (3GPP) access device, etc. Alternatively, the access network device 160 in the embodiments of the present disclosure may include various forms of base stations, such as macro base stations, micro base stations (also known as small stations), relay stations, access points, 5G base stations or future base stations, satellites, transmitting and receiving points (TRPs), transmitting points (TPs), mobile switching centers, as well as device-to-device (D2D), machine-to-machine (M2M), Internet of Things (IoT), vehicle-to-everything (V2X) or other devices that function as base stations in communications, which will not be specifically limited in the embodiments of the present disclosure. For the convenience of description, in all embodiments of the present disclosure, devices that provide a wireless communication function for the terminal device 150 are collectively referred to as access network devices or base stations.

The terminal device 150 in FIG. 1 may be an electronic device that provides voice or data connectivity. For example, the terminal device 150 may also be referred to as user equipment (UE), a subscriber unit, a mobile station, a station, a terminal, etc. By way of example, the terminal device 150 may include a smart phone, a smart wearable device, a smart speaker, a smart tablet, a wireless modem, a wireless local loop (WLL) station, a personal digital assistant (PDA), a customer premise equipment (CPE), etc. With the development of wireless communication technology, devices that can access a communication system, communicate with an access network device 160 of the communication system, and communicate with other objects through the communication system, or two or more devices that can communicate directly with each other can be terminal devices in the embodiments of the present disclosure, for example, terminals and cars in intelligent transportation, household appliances in smart homes, power meter reading instruments, voltage monitoring instruments and environmental monitoring instruments in smart grids, video monitoring instruments in intelligent security networks, cash registers, etc. In an embodiment of the present disclosure, the terminal device 150 can communicate with the access network device 160. A plurality of terminal devices can also communicate with each other. The terminal device 150 may be statically fixed or mobile, which is not limited in the present disclosure.

In some embodiments, the terminal device 150 in FIG. 1 may include a first terminal device 151 and a second terminal device 152, and the first terminal device 151 and the second terminal device 152 may communicate with each other via a sidelink. The sidelink communication between the first terminal device 151 and the second terminal device 152 may be performed in any one or more of unicast, multicast or broadcast. It is to be noted that, in FIG. 1, the above first terminal device 151 may be one or more, and the second terminal device 152 may also be one or more, which is not limited in the present disclosure.

The first terminal device 151 may communicate with the access network device 160 via a non-sidelink, and the non-sidelink may include an uplink and/or a downlink between the first terminal device 151 and the access network device 160. By way of example, the non-sidelink may include one or more links such as a Physical Random Access Channel (PRACH), a Physical Uplink Control Channel (PUCCH), a Physical Uplink Shared Channel (PUSCH), a Physical Downlink Shared Channel (PDSCH), and a Physical Downlink Control Channel (PDCCH).

FIG. 2 illustrates a method for determining a link according to an example, which may be performed by a terminal device in the above communication system, such as a first terminal device. As shown in FIG. 2, the method may include the following steps.

In S201, in response to determining that a sidelink and a non-sidelink of the first terminal device are unable to transmit simultaneously, the first terminal device determines a resource type corresponding to the sidelink.

By way of example, the resource type used by the sidelink may include one or more of a licensed resource and an unlicensed resource. For example, the resource type of the licensed resource is used to represent that the first terminal device may use a spectrum resource licensed by International Telecommunication Union (ITU) or a specific country region for sidelink transmission. The resource type of the unlicensed resource is used to represent that the first terminal device may use an unlicensed spectrum resource for sidelink transmission (Sidelink Unlicense, Sidelink-U). The unlicensed spectrum resource may also be referred to as a shared spectrum resource.

In some embodiments, the terminal device may determine the resource type according to the target resource currently used by the sidelink. By way of example, when the frequency of the target resource of the sidelink is within a frequency corresponding to the unlicensed spectrum resource, it may be determined that the resource type is the unlicensed resource.

It needs to be noted that the target resource currently used by the sidelink may be obtained by the terminal device requesting the access network device, or determined by the terminal device itself. For example, when a bandwidth of a licensed frequency resource of a terminal is limited, the terminal may determine at least one unlicensed frequency resource as the target resource.

In some embodiments, the non-sidelink may be an uplink, and the first device terminal may transmit data to the base station via the uplink. In a case where both the sidelink and the non-sidelink have to-be-transmitted data and need to be transmitted simultaneously, but the sidelink and the non-sidelink are unable to transmit simultaneously due to specific reasons, the terminal device may determine that the sidelink and the non-sidelink are unable to transmit simultaneously. The specific reasons may include: one or more of frequency resource conflict, insufficient transmission power of the terminal device, etc., which is not limited in the present disclosure.

In S202, the first terminal device determines a target link for communication from the sidelink and the non-sidelink according to the resource type.

In this step, the target link may be determined in different ways according to different resource types.

In some embodiments, in a case where the resource type is the unlicensed resource, a sidelink may be preferentially used as the target link to transmit data.

It needs to be noted that in a case where the unlicensed resource is used for sidelink transmitting, a plurality of terminal devices will perform channel monitoring to determine whether link resources (such as frequency resources and channel resources) are idle. If the terminal devices find, through channel monitoring, that certain link resources have not been used by any terminal for transmission within a certain period of time, it may be determined that the link resources are idle, so that the link resources may be occupied for sidelink transmission. Therefore, in the case where the resource type is the unlicensed resource and the sidelink and the non-sidelink are unable to transmit simultaneously, the resources of the sidelink will be idle if the non-sidelink is given priority, and there is a certain probability that the resources of the sidelink will be preempted by other terminal devices, resulting in sidelink transmission failure.

Through the method in the embodiment, in the case where the resource type is the unlicensed resource, the sidelink is preferentially used as the target link, which can prevent the unlicensed resource of the sidelink from being preempted by other terminal devices due to long-term idleness, thereby improving the reliability of sidelink transmission.

In other embodiments, in a case where the resource type is the licensed resource, link selection may be performed in accordance with the method in the related art. For example, a sidelink or a non-sidelink may be selected as the target link according to the principle of fairness. For example, the sidelink and the non-sidelink may be used in turn according to time. For another example, the target link may be randomly selected from the sidelink or the non-sidelink.

By adopting the above method, in a case where it is determined that the sidelink and the non-sidelink of the first terminal device are unable to transmit simultaneously, the resource type used by the sidelink is obtained; and a target link for communication is determined from the sidelink and the non-sidelink according to the resource type. In this way, the target link may be selected according to the resource type, such that the problem of sidelink transmission failure caused by irrational link selection may be avoided.

FIG. 3 illustrates a method for determining a link according to an example. As shown in FIG. 3, the method may include the following steps.

In S301, in response to determining that a sidelink and a non-sidelink of a first terminal device are unable to transmit simultaneously, the first terminal device determines a resource type corresponding to the sidelink.

In S302, the first terminal device determines a target link selection threshold according to the resource type of the sidelink.

By way of example, the target link selection threshold corresponding to the resource type may be determined according to a resource-link correspondence relationship. The resource-link correspondence relationship includes a correspondence relationship between the resource type of the sidelink and a link selection threshold.

In some embodiments, the resource-link correspondence relationship may include a first link selection threshold corresponding to a case where the resource type of the sidelink is an unlicensed resource.

In other embodiments, the resource-link correspondence relationship may include a second link selection threshold corresponding to a case where the resource type of the sidelink is a licensed resource.

In some embodiments, different resource types may correspond to different link selection thresholds. For example, the link selection thresholds corresponding to the licensed resource and the unlicensed resource may be different, that is, the above first link selection threshold and second link selection threshold may be different.

In other embodiments, different resource types may also correspond to the same link selection threshold. For example, the link selection thresholds corresponding to the licensed resource and the unlicensed resource may also be the same, that is, the above first link selection threshold and second link selection threshold may be the same.

In some embodiments of the present disclosure, in the case where the resource type includes the unlicensed resource, the first link selection threshold corresponding to the unlicensed resource may be used as the target link selection threshold according to the resource-link correspondence relationship.

By way of example, in the case where the resource type is the unlicensed resource, the first link selection threshold corresponding to the unlicensed resource may be used as the target link selection threshold.

In some embodiments, the target link selection threshold may include a target sidelink priority threshold and a target non-sidelink priority threshold; the first link selection threshold may also include a first sidelink priority threshold and a first non-sidelink priority threshold; and the above second link selection threshold may also include a second sidelink priority threshold and a second non-sidelink priority threshold.

In this way, different target link selection thresholds are determined according to different resource types, such that flexible target link selection may be achieved.

In some embodiments, the above first sidelink priority threshold may be lower than the second sidelink priority threshold.

In other embodiments, the above first non-sidelink priority threshold may be higher than the second non-sidelink priority threshold.

In yet other embodiments, the above first sidelink priority threshold may be lower than the second sidelink priority threshold, and the above first non-sidelink priority threshold may be higher than the second non-sidelink priority threshold.

Through the above thresholds, the first terminal device may preferentially select the sidelink for transmission in the case where the resource type of the sidelink is the unlicensed resource.

By way of example, the first terminal device may first obtain a first logical channel priority corresponding to the sidelink and a second logical channel priority corresponding to the non-sidelink, and in a case where the first logical channel priority is higher than the target sidelink priority threshold and the second logical channel priority is lower than the target non-sidelink priority threshold, use the sidelink as a target link, that is, transmit the sidelink preferentially.

In this way, in a case where the first sidelink priority threshold is lower than the second sidelink priority threshold, and/or the first non-sidelink priority threshold is higher than the second non-sidelink priority threshold, the first terminal device may preferentially select the sidelink for transmission when using the unlicensed resource.

Through the above method, in the case where the sidelink uses the unlicensed resource and the sidelink and the non-sidelink are unable to transmit simultaneously, the sidelink may be preferentially selected for transmission, preventing the sidelink transmission failure caused by the unlicensed resource transmission by the sidelink being idle and being preempted by other terminals.

In other embodiments of the present disclosure, in the case where the resource type is the unlicensed resource and the first terminal device is not a last terminal within a channel occupancy time (COT), the first link selection threshold corresponding to the unlicensed resource may be used as the target link selection threshold.

It needs to be noted that when the terminal device performs sidelink transmission on the unlicensed resource (such as an unlicensed spectrum resource), the unlicensed resource may be selected for transmission through a Listen Before Talk (LBT) mechanism. The time that the terminal device uses the unlicensed resource for transmission is the COT. The terminal device may also share its own COT with other terminal devices for sidelink transmission. A plurality of terminals that share the same COT may perform sidelink transmission in a negotiated order.

If the first terminal device is not a last transmission terminal sharing the same COT and the transmission of the first terminal device is interrupted, other terminal devices that do not share the COT may preempt the COT, resulting in the terminal devices that share the COT and whose transmission time is after that of the first terminal device being unable to perform sidelink transmission. Therefore, in the embodiment, a separate target link selection threshold may be set for this scenario, such that the first terminal device may preferentially use the sidelink for transmission.

By way of example, in the case where the resource type is the unlicensed resource, the first link selection threshold corresponding to the unlicensed resource may be used as the target link selection threshold. It needs to be noted that the first link selection threshold corresponding to the unlicensed resource may enable the first terminal device to preferentially select the sidelink for transmission.

In some embodiments, the target link selection threshold may include a target sidelink priority threshold and a target non-sidelink priority threshold; and the first link selection threshold may also include a first sidelink priority threshold and a first non-sidelink priority threshold.

In other embodiments of the present disclosure, in the case where the resource type is the licensed resource, the second link selection threshold corresponding to the licensed resource may be used as the target link selection threshold according to the resource-link correspondence relationship.

The second link selection threshold may be the same as or different from the first link selection threshold. In this way, different link selection thresholds are flexibly set for different resource types, thereby realizing a flexible resource allocation strategy.

It needs to be noted that if the resource types currently used by the sidelink of the first terminal device include both the unlicensed resource and the licensed resource, the target resource may also be determined in the manner of the case where the resource type is the unlicensed resource in an embodiment of the present disclosure.

In some embodiments of the present disclosure, the above resource-link correspondence relationship may be determined using one or more of the following methods.

In method 1, a first parameter transmitted by an access network device is received; and a resource-link correspondence relationship is determined according to the first parameter.

In some embodiments, the first parameter may be used to instruct the first terminal device to determine a first link selection threshold in the case where the resource type is the unlicensed resource.

By way of example, the first parameter may include a first link selection threshold corresponding to the unlicensed resource.

In other embodiments, in a case where the first link selection threshold includes a first sidelink priority threshold and a first non-sidelink priority threshold, the first parameter may include a second parameter used for determining the first sidelink priority threshold and a third parameter used for determining the first non-sidelink priority threshold.

By way of example, the first parameter may include: a first sidelink priority threshold and a first non-sidelink priority threshold corresponding to when the resource type is the unlicensed resource.

In yet other embodiments, the first parameter may also be used to instruct the first terminal device to determine a first link selection threshold in the case where the resource type is the unlicensed resource, and a second link selection threshold in the case where the resource type is the licensed resource.

By way of example, the first parameter may include a first link selection threshold corresponding to the unlicensed resource and a second link selection threshold corresponding to the licensed resource.

In further other embodiments, in the case where the first link selection threshold includes a first sidelink priority threshold and a first non-sidelink priority threshold, and the second link selection threshold includes a second sidelink priority threshold and a second non-sidelink priority threshold, the first parameter may include a second parameter used for determining the first sidelink priority threshold, a third parameter used for determining the first non-sidelink priority threshold, a fourth parameter used for determining the second sidelink priority threshold, and a fifth parameter used for determining the second non-sidelink priority threshold.

By way of example, the first parameter may include: a first sidelink priority threshold and a first non-sidelink priority threshold corresponding to when the resource type is the unlicensed resource, and a second sidelink priority threshold and a second non-sidelink priority threshold corresponding to when the resource type is the licensed resource.

In method 2, the first terminal device determines the resource-link correspondence relationship according to preset parameters.

In some embodiments, the preset parameters may include a pre-configured first link selection threshold corresponding to the unlicensed resource.

In other embodiments, the preset parameters may include: a pre-configured first link selection threshold corresponding to the unlicensed resource, and a pre-configured second link selection threshold corresponding to the licensed resource.

It needs to be noted that the first terminal device may also combine the above method 1 and method 2 to determine the above resource-link correspondence relationship. By way of example, the first terminal device may determine the resource-link correspondence relationship according to the first parameter in a case where a first parameter transmitted by the access network device is received; conversely, the first terminal device may determine the resource-link correspondence relationship according to the preset parameters in a case where the first parameter transmitted by the access network device is not received or the received first parameter does not meet preset parameter conditions.

In S303, the first terminal device determines the target link according to the target link selection threshold.

The target link selection threshold may include a target sidelink priority threshold and a target non-sidelink priority threshold. Thus, in this step, a first logical channel priority corresponding to the sidelink and a second logical channel priority corresponding to the non-sidelink may be first obtained; and the target link may then be determined according to the first logical channel priority, the second logical channel priority, the target sidelink priority threshold, and the target non-sidelink priority threshold.

By way of example, the first terminal device may determine the target link according to the relationship between the first logical channel priority and the target sidelink priority threshold as well as the relationship between the second logical channel and the target non-sidelink priority threshold, that is, determine whether to prioritize sidelink transmission or non-sidelink transmission.

In some embodiments, the first terminal device may use the sidelink as the target link in a case where a first preset condition is met, that is, prioritize sidelink transmission.

In addition, the first terminal device may also use the non-sidelink as the target link in a case where the above first preset condition is not met, that is, prioritize non-sidelink transmission (such as uplink transmission).

The first preset condition may include the first logical channel priority being higher than the target sidelink priority threshold, and the second logical channel priority being lower than the target non-sidelink priority threshold.

It needs to be noted that the smaller the value of the priority is, the higher the priority is; alternatively, the larger the value of the priority is, the higher the priority is, which is not limited in the present disclosure.

By way of example, if a smaller value of the priority indicates a higher priority, the above first preset condition may include that: the value of the first logical channel priority is less than the value of the target sidelink priority threshold, and the value of the second logical channel priority is greater than the value of the target non-sidelink priority threshold.

In other embodiments, the first terminal device may use the non-sidelink as the target link in a case where a second preset condition is met, that is, prioritize non-sidelink transmission, and use the sidelink as the target link in a case where the second preset condition is not met, that is, prioritize sidelink transmission.

The second preset condition may include the first logical channel priority being lower than the target sidelink priority threshold, and the second logical channel priority being higher than the target non-sidelink priority threshold.

In this way, a target link may be determined more flexibly according to logical channel priorities and link priority thresholds.

It needs to be noted that the above target link selection threshold may include a target sidelink priority threshold and a target non-sidelink priority threshold; the above first link selection threshold may also include a first sidelink priority threshold and a first non-sidelink priority threshold; and the above second link selection threshold may also include a second sidelink priority threshold and a second non-sidelink priority threshold.

In some embodiments, the above first sidelink priority threshold may be lower than the second sidelink priority threshold.

In other embodiments, the above first non-sidelink priority threshold may be higher than the second non-sidelink priority threshold.

In yet other embodiments, the above first sidelink priority threshold may be lower than the second sidelink priority threshold, and the above first non-sidelink priority threshold may be higher than the second non-sidelink priority threshold.

By adopting the above method, in a case where the sidelink uses the unlicensed resource and the sidelink and the non-sidelink are unable to transmit simultaneously, the sidelink may be preferentially selected for transmission, thereby avoiding the sidelink transmission failure caused by an idle unlicensed resource transmitted by the sidelink being preempted by other terminals.

In some embodiments, the first logical channel priority may be a priority of a logical channel with the highest priority among at least one logical channel corresponding to the sidelink, where the at least one logical channel has to-be-transmitted data.

By way of example, if the sidelink of the first terminal device includes N logical channels having to-be-transmitted data, the priority of the logical channel with the highest priority among the N logical channels may be used as the first logical channel priority.

In other embodiments, the first logical channel priority may be a priority of a logical channel with the lowest priority among at least one logical channel corresponding to the sidelink, where the at least one logical channel has to-be-transmitted data.

In yet other embodiments, the first logical channel priority may be an average value of priorities of at least one logical channel corresponding to the sidelink, where the at least one logical channel has to-be-transmitted data.

In some embodiments, the second logical channel priority may be a priority of a logical channel with the highest priority among at least one logical channel corresponding to the non-sidelink, where the at least one logical channel has to-be-transmitted data.

In other embodiments, the second logical channel priority may be a priority of a logical channel with the lowest priority among at least one logical channel corresponding to the non-sidelink, where the at least one logical channel has to-be-transmitted data.

In yet other embodiments, the second logical channel priority may be an average value of priorities of at least one logical channel corresponding to the non-sidelink, where the at least one logical channel has to-be-transmitted data.

In this way, the above logical channel priorities may be flexibly determined according to requirements.

In some embodiments of the present disclosure, the above first logical channel priority may be determined through the following steps.

First, in the case where the resource type is an unlicensed resource, at least one second terminal device that shares the same channel occupancy time (COT) with the first terminal device is determined.

In some embodiments, the second terminal device may be a terminal device that shares the same COT with the first terminal device and does not use the COT for data transmission.

In other embodiments, the second terminal device may be any terminal device that shares the same COT with the first terminal device.

The first logical channel priority is then determined according to at least one logical channel corresponding to a sidelink between the first terminal device and the second terminal device.

In some embodiments, the priority of the logical channel with the highest priority among at least one logical channel corresponding to the sidelink between the first terminal device and the second terminal device may be used as the first logical channel priority, where the at least one logical channel has to-be-transmitted data.

By way of example, the sidelink of the first terminal device includes N logical channels having to-be-transmitted data. There are K second terminal devices, and the sidelink of each second terminal device includes M logical channels having to-be-transmitted data, such that there are a total of (N+K*M) logical channels having to-be-transmitted data. The priority of the logical channel with the highest priority among these (N+K*M) logical channels may be used as the first logical channel priority.

In other embodiments, the priority of the logical channel with the lowest priority among at least one logical channel corresponding to the sidelink between the first terminal device and the second terminal device may be used as the first logical channel priority, where the at least one logical channel has to-be-transmitted data.

In yet other embodiments, an average value of priorities of at least one logical channel corresponding to the sidelink between the first terminal device and the second terminal device may be used as the first logical channel priority, where the at least one logical channel has to-be-transmitted data.

By adopting the above method, logical channel priorities corresponding to logical channels of a plurality of terminal devices (such as the above first terminal device and the second terminal device) that share the same COT may be taken into account, a maximum value, a minimum value or an average value among them may be selected as the above first logical channel priority, and a target link may be further determined according to the first logical channel priority, the target sidelink priority threshold, the second logical channel priority, and the target non-sidelink priority threshold. Thus, a plurality of terminal devices that share the same COT are taken into account when determining a target link, such that the target link may be determined more comprehensively and accurately, and the unlicensed resource corresponding to the sidelink is prevented from being occupied by other terminal devices.

In some embodiments of the present disclosure, the first terminal device may receive a fifth logical channel priority transmitted by the second terminal device. The fifth logical channel priority represents a priority of at least one logical channel corresponding to the sidelink of the second terminal device, where the at least one logical channel has to-be-transmitted data. For example, the fifth logical channel may be a priority of a logical channel with the highest priority among at least one logical channel corresponding to the sidelink of the second terminal device, where the at least one logical channel has to-be-transmitted data.

The second terminal device may be a terminal device that shares the same COT with the first terminal device. The second terminal device may also be a terminal device that shares the same COT with the first terminal device and does not use the COT for data transmission.

By way of example, among a plurality of terminal devices that share the same COT, any terminal device may transmit its own logical channel priority to other terminal devices.

It needs to be noted that the terminal device may transmit the above logical channel priorities through one or more of a sidelink radio resource control (sidelink RRC) message, a sidelink medium access control control element (sidelink MAC CE), or sidelink control information (SCI). The terminal device may also receive the above logical channel priorities through one or more of the sidelink RRC message, or sidelink MAC CE, and the SCI.

In yet other embodiments of the present disclosure, the first terminal device may receive resource location information transmitted by the second terminal device. The resource location information may be used to represent location information for data transmission by the second terminal device through the COT.

In some embodiments, the resource location information may represent a sorting location for data transmission by the second terminal device through the COT.

In other embodiments, the resource location information may include one or more of time location information or frequency location information.

In this way, the first terminal device may determine, according to the resource location information, at least one second terminal device that shares the same COT with the first terminal device and does not use the COT for data transmission.

FIG. 4 illustrates a method for determining a link according to an example. As shown in FIG. 4, the method may include the following steps.

In S401, in response to determining that that a sidelink and a non-sidelink of a first terminal device are unable to transmit simultaneously, the first terminal device determines a resource type corresponding to the sidelink.

In S402, in a case where the resource type is an unlicensed resource, at least one second terminal device that shares the same channel occupancy time (COT) with the first terminal device is determined.

In some embodiments, the second terminal device may be a terminal device that shares the same COT with the first terminal device and does not use the COT for data transmission.

In other embodiments, the second terminal device may be any terminal device that shares the same COT with the first terminal device.

In S403, a third logical channel priority is determined according to at least one logical channel corresponding to a sidelink between the first terminal device and the second terminal device.

In some embodiments, the priority of the logical channel with the highest priority among at least one logical channel corresponding to the sidelink between the first terminal device and the second terminal device may be used as the third logical channel priority, where the at least one logical channel has to-be-transmitted data.

By way of example, the sidelink of the first terminal device includes N logical channels having to-be-transmitted data. There are K second terminal devices, and the sidelink of each second terminal device includes M logical channels having to-be-transmitted data, such that there are a total of (N+K*M) logical channels having to-be-transmitted data. The priority of the logical channel with the highest priority among the (N+K*M) logical channels may be used as the first logical channel priority.

In other embodiments, the priority of the logical channel with the lowest priority among the at least one logical channel corresponding to the sidelink between the first terminal device and the second terminal device may be used as the third logical channel priority, where the at least one logical channel has to-be-transmitted data.

In yet other embodiments, the average value of priorities of at least one logical channel corresponding to the sidelink between the first terminal device and the second terminal device may be used as the third logical channel priority, where the at least one logical channel has to-be-transmitted data.

In S404, a fourth logical channel priority is determined according to at least one logical channel corresponding to a non-sidelink of the first terminal device.

In some embodiments, the fourth logical channel priority may be a priority of a logical channel with the highest priority among at least one logical channel corresponding to the non-sidelink, where the at least one logical channel has to-be-transmitted data.

In other embodiments, the fourth logical channel priority may be a priority of a logical channel with the lowest priority among the at least one logical channel corresponding to the non-sidelink, where the at least one logical channel has to-be-transmitted data.

In yet other embodiments, the fourth logical channel priority may be an average value of priorities of the at least one logical channel corresponding to the non-sidelink, where the at least one logical channel has to-be-transmitted data.

In S405, a target link is determined according to the third logical channel priority and the fourth logical channel priority.

In this step, the target link may be determined in many ways, for example:

In some embodiments, in a case where the third logical channel priority is greater than or equal to the fourth logical channel priority, the sidelink may be used as the target link.

In other embodiments, in a case where the third logical channel priority is less than the fourth logical channel priority, the non-sidelink may be used as the target link.

In yet other embodiments, a sidelink priority threshold and a non-sidelink priority threshold may be determined first, and the target link may then be determined according to the third logical channel priority, the fourth logical channel priority, the sidelink priority threshold, and the non-sidelink priority threshold.

By way of example, the first terminal device may determine the target link according to a relationship between the third logical channel priority and the sidelink priority threshold as well as a relationship between the fourth logical channel and the non-sidelink priority threshold, that is, determine whether to prioritize sidelink transmission or non-sidelink transmission.

In some embodiments, the first terminal device may use the sidelink as the target link in a case where a third preset condition is met, that is, prioritize sidelink transmission.

In addition, the first terminal device may also use the non-sidelink as the target link in a case where the above third preset condition is not met, that is, prioritize non-sidelink transmission (such as uplink transmission).

The third preset condition may include the third logical channel priority being higher than the sidelink priority threshold, and the fourth logical channel priority being lower than the non-sidelink priority threshold.

It needs to be noted that the smaller the value of the priority is, the higher the priority is; alternatively, the larger the value of the priority is, the higher the priority is, which is not limited in the present disclosure.

In some embodiments of the present disclosure, the first terminal device may receive a fifth logical channel priority transmitted by the second terminal device. The fifth logical channel priority represents a priority of at least one logical channel corresponding to the sidelink of the second terminal device, where the at least one logical channel has to-be-transmitted data. For example, the fifth logical channel may be a priority of a logical channel with the highest priority among at least one logical channel corresponding to the sidelink of the second terminal device, where the at least one logical channel has to-be-transmitted data.

The second terminal device may be a terminal device that shares the same COT with the first terminal device. The second terminal device may also be a terminal device that shares the same COT with the first terminal device and does not use the COT for data transmission.

By way of example, among a plurality of terminal devices that share the same COT, any terminal device can transmit its own logical channel priority to other terminal devices.

It needs to be noted that the terminal device may transmit the above logical channel priorities through one or more of a sidelink RRC message, a sidelink MAC CE, or SCI. The terminal device may also receive the above logical channel priorities through one or more of the sidelink RRC messages, the sidelink MAC CE, or the SCI.

In yet other embodiments of the present disclosure, the first terminal device may receive resource location information transmitted by the second terminal device. The resource location information may be used to represent location information for data transmission by the second terminal device through the COT.

In some embodiments, the resource location information may represent a sorting location for data transmission by the second terminal device through the COT.

In other embodiments, the resource location information may include one or more of time location information or frequency location information.

In this way, the first terminal device may determine, according to the resource location information, at least one second terminal device that shares the same COT with the first terminal device and does not use the COT for data transmission.

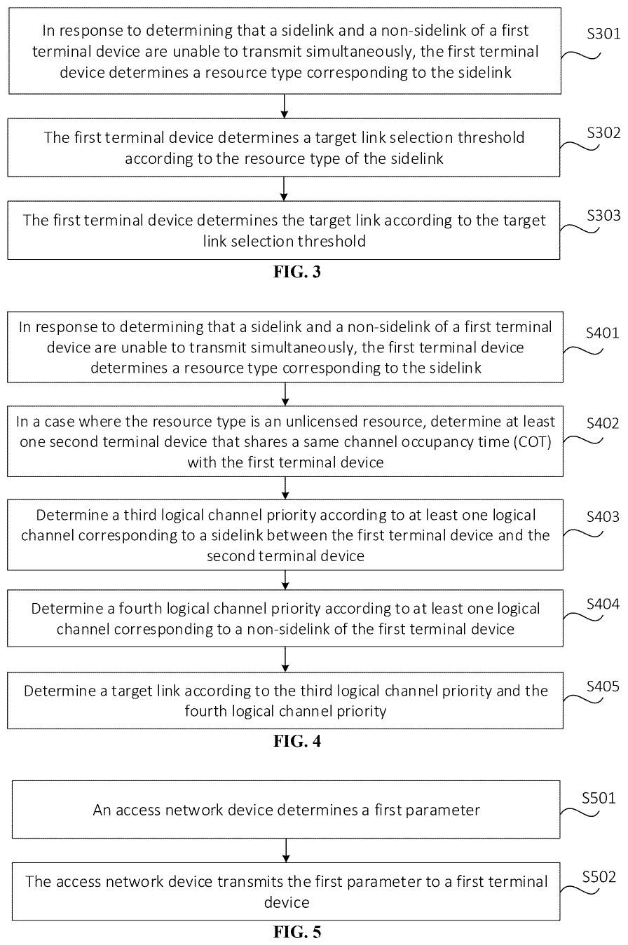

FIG. 5 illustrates a method for determining a link according to an example, which may be performed by an access network device in the above communication system. As shown in FIG. 5, the method may include the following steps.

In S501, the access network device determines a first parameter.

In S502, the access network device transmits the first parameter to a first terminal device.

The first parameter is used to determine a first link selection threshold in a case where a resource type used by the sidelink is an unlicensed resource to instruct the first terminal device to determine a resource-link correspondence relationship according to the first parameter, determine a target link selection threshold corresponding to the resource type of the sidelink according to the resource-link correspondence relationship, and determine a target link for communication according to the target link selection threshold.

Using the above method, the access network device may transmit a first parameter to the first terminal device, and may instruct the first terminal device to determine, according to the first parameter, a first link selection threshold in the case where the resource type used by the sidelink is the unlicensed resource, so as to determine a target link selection threshold in the case where the resource type is the unlicensed resource, and determine a target link for communication according to the target link selection threshold. A target link may be selected according to the resource type so that the problem of sidelink transmission failure caused by irrational link selection may be avoided.

In some embodiments, the above first parameter may be used to instruct the first terminal device to determine a first link selection threshold in the case where the resource type is the unlicensed resource.

By way of example, the first parameter may include a first link selection threshold corresponding to the unlicensed resource.

Further, the above first link selection threshold may include a first sidelink priority threshold and a first non-sidelink priority threshold, and the first parameter may include a second parameter used for determining the first sidelink priority threshold and a third parameter used for determining the first non-sidelink priority threshold.

By way of example, the first parameter may include: a first sidelink priority threshold and a first non-sidelink priority threshold corresponding to the case where the resource type is the unlicensed resource.

In other embodiments, the first parameter may be used to instruct the first terminal device to determine a second link selection threshold in a case where the resource type is a licensed resource.

By way of example, the first parameter may include a second link selection threshold corresponding to the licensed resource.

Further, the above second link selection threshold may include a second sidelink priority threshold and a second non-sidelink priority threshold, and the first parameter may include a fourth parameter used for determining the second sidelink priority threshold and a fifth parameter used for determining the second non-sidelink priority threshold.

By way of example, the first parameter may include: a second sidelink priority threshold and a second non-sidelink priority threshold corresponding to the case where the resource type is the licensed resource.

In yet other embodiments, the first parameter may also be used to instruct the first terminal device to determine a first link selection threshold in the case where the resource type is the unlicensed resource, and a second link selection threshold in the case where the resource type is the licensed resource.

Further, the first link selection threshold may include a first sidelink priority threshold and a first non-sidelink priority threshold, and the second link selection threshold also includes a second sidelink priority threshold and a second non-sidelink priority threshold.

In some embodiments, the above sidelink is a communication link between the first terminal device and a terminal device other than the first terminal device; and the above non-sidelink is an uplink between the first terminal device and the access network device.

In some embodiments, the access network device may transmit the above first parameter to the terminal device (e.g., the first terminal device or the second terminal device) via one or more of a system message or an RRC message.

For example, the access network device may transmit the above first parameter to the terminal device via a system information block 12 (SIB12) in the system message or other SIB messages.

For another example, the access network device may transmit the above first parameter to the terminal device via an RRC reconfiguration message or other RRC messages.

It needs to be noted that, in the embodiment, the first terminal device determines the target link selection threshold corresponding to the resource type of the sidelink, and determines a specific method of the target link for communication according to the target link selection threshold, which may be referred to the description in the above other embodiments and will not be repeated here in the present disclosure.

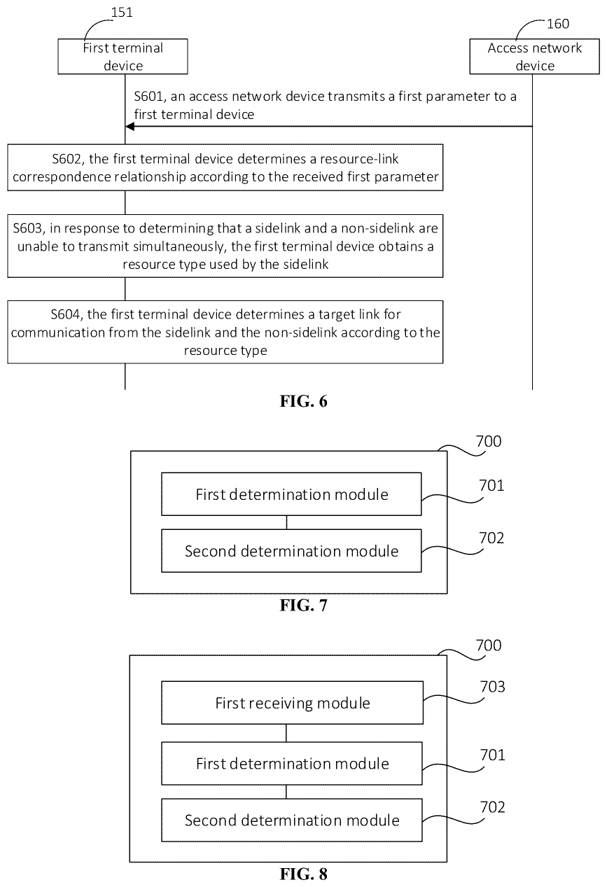

FIG. 6 illustrates a method for determining a link illustrated according to an example. As shown in FIG. 6, the method may include the following steps.

In S601, an access network device transmits a first parameter to a first terminal device.

In S602, the first terminal device determines a resource-link correspondence relationship according to the received first parameter.

The resource-link correspondence relationship includes a correspondence relationship between a resource type of a sidelink and a link selection threshold.

In some embodiments, the resource-link correspondence relationship may include a first link selection threshold corresponding to a case where the resource type of the sidelink is an unlicensed resource. The above first parameter may be used to instruct the first terminal device to determine the first link selection threshold in the case where the resource type is the unlicensed resource. In this way, the first terminal device may determine, according to the first parameter, the first link selection threshold corresponding to the case where the resource type is the unlicensed resource.

Further, the above first link selection threshold may include a first sidelink priority threshold and a first non-sidelink priority threshold, and the first parameter may include a second parameter used for determining the first sidelink priority threshold and a third parameter used for determining the first non-sidelink priority threshold. In this way, the first terminal device may determine the first sidelink priority threshold according to the second parameter, and determine the first non-sidelink priority threshold according to the third parameter.

In other embodiments, the resource-link correspondence relationship may include a second link selection threshold corresponding to a case where the resource type of the sidelink is a licensed resource. The above first parameter may be used to instruct the first terminal device to determine the second link selection threshold in the case where the resource type is the licensed resource. In this way, the first terminal device can determine, according to the first parameter, the second link selection threshold corresponding to the case where the resource type is the licensed resource.

Further, the above second link selection threshold may include a second sidelink priority threshold and a second non-sidelink priority threshold, and the first parameter may include a fourth parameter used for determining the second sidelink priority threshold and a fifth parameter used for determining the second non-sidelink priority threshold. In this way, the first terminal device may determine the second sidelink priority threshold according to the fourth parameter, and determine the second non-sidelink priority threshold according to the fifth parameter.

In yet other embodiments, the resource-link correspondence relationship may include a first link selection threshold corresponding to the case where the resource type of the sidelink is the unlicensed resource, and a second link selection threshold corresponding to the case where the resource type of the sidelink is a licensed resource.

In S603, in response to determining that a sidelink and a non-sidelink are unable to transmit simultaneously, the first terminal device obtains a resource type used by the sidelink.

By way of example, the resource type used by the sidelink may include one or more of the licensed resource or the unlicensed resource.

In S604, the first terminal device determines a target link for communication from the sidelink and the non-sidelink according to the resource type.

By way of example, the first terminal device may determine a target link selection threshold corresponding to the resource type according to the above resource-link correspondence relationship, and determine a target link according to the target link selection threshold.

It needs to be noted that the specific method in which the first terminal device determines the target link may be referred to the description in the above embodiments and will not be repeated here.

Using the above method, the first terminal device may determine a resource-link correspondence relationship according to the first parameter transmitted by the access network device, and obtain a resource type used by the sidelink in the case of determining that the sidelink and the non-sidelink are unable to transmit simultaneously; and determine a target link for communication from the sidelink and the non-sidelink according to the resource type. In this way, a target link may be selected according to the resource type, such that the problem of sidelink transmission failure caused by irrational link selection may be avoided.

FIG. 7 is a block diagram illustrating a device 700 for determining a link according to an example, which is applied to a first terminal device. As shown in FIG. 7, the device 700 may include:
a first determination module 701, configured to determine, in response to determining that a sidelink and a non-sidelink of the first terminal device are unable to transmit simultaneously, a resource type corresponding to the sidelink; and
a second determination module 702, configured to determine a target link for communication from the sidelink and the non-sidelink according to the resource type.

In some embodiments, the second determination module 702 is configured to determine a target link selection threshold according to the resource type of the sidelink, different resource types corresponding to different link selection thresholds; and determine the target link according to the target link selection threshold.

In some embodiments, the second determination module 702 is configured to determine the target link selection threshold corresponding to the resource type according to a resource-link correspondence relationship. The resource-link correspondence relationship includes a correspondence relationship between the resource type of the sidelink and a link selection threshold.

FIG. 8 is a block diagram illustrating a device 700 for determining a link according to an example. As shown in FIG. 8, the device 700 may also include:
a first receiving module 703, configured to receive a first parameter transmitted by an access network device, where the first parameter is used to instruct the first terminal device to determine a first link selection threshold in a case where the resource type is an unlicensed resource; and
the second determining module 702, configured to determine the resource-link correspondence relationship according to the first parameter.

In some embodiments, the second determination module 702 is configured to use the first link selection threshold corresponding to the unlicensed resource as the target link selection threshold according to the resource-link correspondence relationship in the case where the resource type is the unlicensed resource.

In some embodiments, the second determination module 702 is configured to use the first link selection threshold corresponding to the unlicensed resource as the target link selection threshold in the case where the resource type is the unlicensed resource and the first terminal device is not a last terminal within a channel occupancy time (COT).

In some embodiments, the target link selection threshold includes a target sidelink priority threshold and a target non-sidelink priority threshold. The second determination module 702 is configured to obtain a first logical channel priority corresponding to the sidelink and a second logical channel priority corresponding to the non-sidelink; and determine the target link according to the first logical channel priority, the second logical channel priority, the target sidelink priority threshold, and the target non-sidelink priority threshold.

In some embodiments, the second determination module 702 is configured to use the sidelink as the target link in a case where a first preset condition is met. The first preset condition includes that the first logical channel priority is higher than the target sidelink priority threshold and that the second logical channel priority is lower than the target non-sidelink priority threshold.

In some embodiments, the first logical channel priority is a priority of a logical channel with the highest priority among at least one logical channel corresponding to the sidelink, where the at least one logical channel has to-be-transmitted data; and the second logical channel priority is a priority of a logical channel with the highest priority among at least one logical channel corresponding to the non-sidelink, where the at least one logical channel has to-be-transmitted data.

In some embodiments, the second determination module 702 is configured to determine, in the case where the resource type is the unlicensed resource, at least one second terminal device that shares the same COT with the first terminal device; determine a third logical channel priority according to the at least one logical channel corresponding to a sidelink between the first terminal device and the second terminal device; determine a fourth logical channel priority according to the at least one logical channel corresponding to the non-sidelink of the first terminal device; and determine the target link according to the third logical channel priority and the fourth logical channel priority.

In some embodiments, the second terminal device is a terminal device that shares the same COT with the first terminal device and does not use the COT for data transmission.

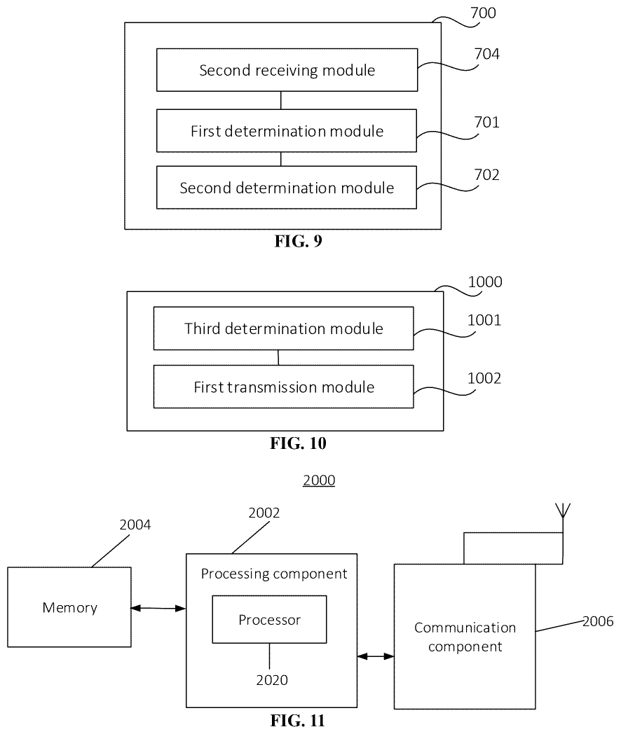

FIG. 9 is a block diagram illustrating a device 700 for determining a link according to an example. As shown in FIG. 9, the device 700 may also include:
a second receiving module 704, configured to receive a fifth logical channel priority transmitted by the second terminal device. The fifth logical channel priority represents a priority of at least one logical channel corresponding to the sidelink of the second terminal device, where the at least one logical channel has to-be-transmitted data.

In some embodiments, the second receiving module 704 is configured to receive resource location information transmitted by the second terminal device. The resource location information represent location information for data transmission by the second terminal device through the COT.

The second determination module 702 is configured to determine, according to the resource location information, at least one second terminal device that shares the same COT with the first terminal device and does not use the COT for data transmission.

In some embodiments, the resource location information includes one or more of time location information or frequency location information.

In some embodiments, the second determination module 702 is configured to use a priority of a logical channel with the highest priority among at least one logical channel corresponding to the sidelink between the first terminal device and the second terminal device as the third logical channel priority, where the at least one logical channel has to-be-transmitted data.

In some embodiments, the second determination module 702 is configured to use the priority of the logical channel with the highest priority among at least one logical channel corresponding to the non-sidelink of the first terminal device as the fourth logical channel priority, where the at least one logical channel has to-be-transmitted data.

In some embodiments, the sidelink is a communication link between the first terminal device and a terminal device other than the first terminal device; and the non-sidelink is an uplink between the first terminal device and the access network device.

FIG. 10 is a block diagram illustrating a device 1000 for determining a link according to an example, which is applied to an access network device. As shown in FIG. 10, the device 1000 may include:
a third determination module 1001, configured to determine a first parameter; and
a first transmission module 1002, configured to transmit the first parameter to a first terminal device, where the first parameter is used to determine a first link selection threshold in a case where a resource type used by the sidelink is an unlicensed resource to instruct the first terminal device to determine a resource-link correspondence relationship according to the first parameter, determine a target link selection threshold corresponding to the resource type of the sidelink according to the resource-link correspondence relationship, and determine a target link for communication according to the target link selection threshold.

In some embodiments, the first link selection threshold includes a first sidelink priority threshold and a first non-sidelink priority threshold; and the first parameter includes a second parameter used for determining the first sidelink priority threshold, and a third parameter used for determining the first non-sidelink priority threshold.

In some embodiments, the sidelink is a communication link between the first terminal device and a terminal device other than the first terminal device; and the non-sidelink is an uplink between the first terminal device and the access network device.

Regarding the device in the above embodiments, the specific manner in which each module performs operations has been described in detail in the embodiments of the method, and will not be elaborated here.

FIG. 11 is a block diagram illustrating a device for determining a link according to an example. A device 2000 for determining a link may be a terminal device in the communication system shown in FIG. 1, or may be an access network device in the communication system.

Referring to FIG. 11, the device 2000 may include one or more of the following components: a processing component 2002, a memory 2004, and a communication component 2006.

The processing component 2002 may be used for controlling overall operations of the device 2000, such as operations associated with display, telephone calls, data communications, camera operations, and recording operations. The processing component 2002 may include one or more processors 2020 to execute instructions to complete all or part of the steps of the method for determining a link described above. In addition, the processing component 2002 may include one or more modules to facilitate the interaction between the processing component 2002 and other components. For instance, the processing component 2002 may include a multimedia module to facilitate the interaction between the multimedia component and the processing component 2002.

The memory 2004 is configured to store various types of data to support operations on the device 2000. Examples of such data include instructions for any applications or methods operated on the device 2000, contact data, phonebook data, messages, pictures, videos, etc. The memory 2004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 2006 is configured to facilitate communication, wired or wirelessly, between the device 2000 and other devices. The device 2000 may access a wireless network based on a communication standard, such as Wi-Fi, 2G, 3G, 4G, 5G, 6G, NB-IOT, eMTC, etc., or a combination of them. In an example, the communication component 2006 receives a broadcast signal or broadcast associated information from an external broadcast management system via a broadcast channel. In an example, the communication component 2006 also includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example, the device 2000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods for determining a link.

In addition to being an independent electronic device, the device 2000 may also be part of an independent electronic device. For example, in an embodiment, the electronic device may be an integrated circuit (IC) or a chip. The integrated circuit may be an IC or a set of a plurality of ICs. The chip may include, but is not limited to, the following types: a graphics processing unit (GPU), a central processing unit (CPU), a field programmable gate array (FPGA), a digital signal processor (DSP), an application specific integrated circuit (ASIC), a system on chip (SOC), etc. The above integrated circuit or chip may be used to execute executable instructions (or codes), so as to implement the above methods for determining a link. The executable instructions may be stored in the integrated circuit or chip, or derived from other devices or devices. For example, the integrated circuit or chip includes a processor, a memory, and an interface for communication with other devices. The executable instructions may be stored in the processor. When the executable instructions are executed by the processor, the above methods for determining a link are implemented. Alternatively, the integrated circuit or chip may receive the executable instructions through the interface, and transmit the instructions to the processor for execution, so as to implement the above methods for determining a link.

In an example, the present disclosure also provides a computer-readable storage medium storing computer program instructions thereon. When the program instructions are executed by a processor, the steps of the methods for determining a link provided by the present disclosure are implemented. For example, the computer-readable storage medium may be a non-transitory computer-readable storage medium that includes instructions. For example, the computer-readable storage medium may be the above memory 2004 including instructions, which may be executed by a processor 2020 of the device 2000 to complete the above methods for determining a link. For example, the non-transitory, computer-readable storage medium may be an ROM, a random access memory (RAM), a compact disc read-only memory (CD-ROM), a magnetic tape, a floppy disk, an optical data storage device, etc.

In another example, a computer program product is also provided. The computer program product includes a computer program capable of being executed by a programmable device. The computer program has a code portion for performing the method for determining a link described above when executed by the programmable device.

Other embodiments of the present disclosure will be readily conceivable to those skilled in the art from consideration of the specification and practice of the present disclosure. The present application is intended to cover any variations, uses, or adaptations of the present disclosure, and these variations, uses, or adaptations follow the general principles of the present disclosure and include common general knowledge or customarily used technical means which are not disclosed herein. The specification and embodiments are to be considered as exemplary merely, and the true scope and spirit of the present disclosure are indicated by the following claims.

It will be appreciated that the present disclosure is not limited to the exact construction that has been described above and illustrated in the accompanying drawings, and that various modifications and changes can be made without departing from their scope. The scope of the present disclosure is merely limited by the appended claims.

1. A method for determining a link, performed by a first terminal device, comprising:
determining, in response to determining that a sidelink and a non-sidelink of the first terminal device are unable to transmit simultaneously, a resource type of the sidelink; and
determining a target link for communication from the sidelink and the non-sidelink according to the resource type.

2. The method according to claim 1, wherein determining the target link for the communication from the sidelink and the non-sidelink according to the resource type comprises:
determining a target link selection threshold according to the resource type of the sidelink, wherein different resource types correspond to different link selection thresholds; and
determining the target link according to the target link selection threshold.

3. The method according to claim 2, wherein determining the target link selection threshold according to the resource type of the sidelink comprises:
determining the target link selection threshold corresponding to the resource type according to a resource-link correspondence relationship, wherein the resource-link correspondence relationship comprises a correspondence relationship between a resource type of the sidelink and a link selection threshold.

4. The method according to claim 3, wherein the resource-link correspondence relationship is determined by:
receiving a first parameter transmitted by an access network device, wherein the first parameter is configured to instruct the first terminal device to determine a first link selection threshold in a case where the resource type is an unlicensed resource; and
determining the resource-link correspondence relationship according to the first parameter.

5. The method according to claim 3, wherein determining the target link selection threshold corresponding to the resource type according to the resource-link correspondence relationship comprises:
determining a first link selection threshold corresponding to an unlicensed resource as the target link selection threshold according to the resource-link correspondence relationship, in a case where the resource type is the unlicensed resource.

6. The method according to claim 3, wherein determining the target link selection threshold corresponding to the resource type according to the resource-link correspondence relationship comprises:
determining a first link selection threshold corresponding to an unlicensed resource as the target link selection threshold, in a case where the resource type is the unlicensed resource and the first terminal device is not a last terminal within a channel occupancy time (COT).

7. The method according to claim 2, wherein the target link selection threshold comprises a target sidelink priority threshold and a target non-sidelink priority threshold; and determining the target link according to the target link selection threshold comprises:
obtaining a first logical channel priority corresponding to the sidelink and a second logical channel priority corresponding to the non-sidelink; and
determining the target link according to the first logical channel priority, the second logical channel priority, the target sidelink priority threshold, and the target non-sidelink priority threshold.

8. The method according to claim 7, wherein determining the target link according to the first logical channel priority, the second logical channel priority, the target sidelink priority threshold, and the target non-sidelink priority threshold comprises:
determining the sidelink as the target link in a case where a first preset condition is met, wherein the first preset condition comprises that the first logical channel priority is higher than the target sidelink priority threshold and that the second logical channel priority is lower than the target non-sidelink priority threshold.

9. The method according to claim 7, wherein
the first logical channel priority is a priority of a logical channel with a highest priority among at least one logical channel corresponding to the sidelink, wherein the at least one logical channel has to-be-transmitted data; and
the second logical channel priority is a priority of a the logical channel with a highest priority among at least one logical channel corresponding to the non-sidelink, wherein the at least one logical channel has to-be-transmitted data.

10. The method according to claim 1, wherein determining the target link for the communication from the sidelink and the non-sidelink according to the resource type comprises:
determining at least one second terminal device that shares a same channel occupancy time (COT) with the first terminal device in a case where the resource type is an unlicensed resource;
determining a third logical channel priority according to at least one logical channel corresponding to a sidelink between the first terminal device and the at least one second terminal device;
determining a fourth logical channel priority according to at least one logical channel corresponding to the non-sidelink of the first terminal device; and
determining the target link according to the third logical channel priority and the fourth logical channel priority.

11. The method according to claim 10, wherein
the at least one second terminal device is a terminal device that shares the same COT with the first terminal device and does not use the COT for data transmission.

12. The method according to claim 10, further comprising:
receiving a fifth logical channel priority transmitted by the at least one second terminal device, wherein the fifth logical channel priority represents a priority of at least one logical channel corresponding to a sidelink of the at least one second terminal device, wherein the at least one logical channel has to-be-transmitted data.

13. The method according to claim 10, further comprising:
receiving resource location information transmitted by the at least one second terminal device, wherein the resource location information represent location information for data transmission by the second terminal device through the COT;
determining the at least one second terminal device that shares the same COT with the first terminal device comprises:
determining, according to the resource location information, the at least one second terminal device that shares the same COT with the first terminal device and does not use the COT for data transmission.

14. The method according to claim 13, wherein the resource location information comprises one or more of time location information or frequency location information.

15. The method according to claim 10, wherein determining the third logical channel priority according to the at least one logical channel corresponding to the sidelink between the first terminal device and the at least one second terminal device comprises:
determining a priority of a logical channel with a highest priority among the at least one logical channel corresponding to the sidelink between the first terminal device and the at least one second terminal device as the third logical channel priority, wherein the at least one logical channel has to-be-transmitted data.

16. The method according to claim 10, wherein determining the fourth logical channel priority according to the at least one logical channel corresponding to the non-sidelink of the first terminal device comprises:
determining a priority of a logical channel with a highest priority among the at least one logical channel corresponding to the non-sidelink of the first terminal device as the fourth logical channel priority, wherein the at least one logical channel has to-be-transmitted data.

17. (canceled)

18. A method for determining a link, performed by an access network device, comprising:
determining a first parameter; and
transmitting the first parameter to a first terminal device, wherein the first parameter is configured to determine a first link selection threshold in a case where a resource type of a sidelink is an unlicensed resource to instruct the first terminal device to determine a resource-link correspondence relationship according to the first parameter, determine a target link selection threshold corresponding to the resource type of the sidelink according to the resource-link correspondence relationship, and determine a target link for communication according to the target link selection threshold.

19. The method according to claim 18, wherein the first link selection threshold comprises a first sidelink priority threshold and a first non-sidelink priority threshold; and the first parameter comprises a second parameter configured to determine the first sidelink priority threshold, and a third parameter configured to determine the first non-sidelink priority threshold.

20-22. (canceled)

23. An electronic device, comprising:
one or more processors; and
a memory that stores processor-executable instructions;
wherein the one or more processors are collectively configured to:
determine, in response to determining that a sidelink and a non-sidelink of a first terminal device are unable to transmit simultaneously, a resource type of the sidelink; and
determine a target link for communication from the sidelink and the non-sidelink according to the resource type.

24-25. (canceled)

26. An electronic device comprising:
one or more processors; and
a memory that stores processor-executable instructions;
wherein the processor-executable instructions when collectively executed by the one or more processors cause the electronic device to act as the access network device and perform the method according to claim 18.
